(19) United States
(12) Patent Application Publication
(10) Pub. No.: US 2003/0102661 A1
(43) Pub. Date: Jun. 5, 2003

(54) Authenticatable 3-dimensional object and method for protecting and identifying objects produced by a foundery technique

(76) Inventor: Marie-Odile Camdessus, Paris (FR)

Correspondence Address: WEINGARTEN, SCHURGIN, GAGNEBIN & LEBOVICI LLP, TEN POST OFFICE SQUARE, BOSTON, MA, 02109, US

(21) Appl. No.: 10/149,571

(22) PCT Filed: Dec. 13, 2000
(86) PCT No.: PCT/FR00/03502

(30) Foreign Application Priority Data
Dec. 13, 1999 (FR) 99/15662

(51) Int. Cl. B42D 15/00

(52) U.S. Cl. 283/74; 283/72

(57) ABSTRACT

In the method of protecting and identifying a three-dimensional article such as a work of art, a precious article, or an industrial component that is made by a foundry, casting, or like technique, marker elements (50) are included in the main material (30) of the article during manufacture thereof, the nature of the marker elements being different from that of the main material (30) of the article so as to react to means for non-destructive investigation of the internal structure of the article in a manner that is different from said main material (30) of the article, metal marker elements (50) constituted by balls are selected that present a melting point higher than that of the main metal material (30) of the article, the marker elements (50) in the solid state are introduced in random manner and without premixing into the main material (30) of the article while it is in the liquid state and the article is being cast, and after the article has been made, it is identified by identifying marker elements in the internal structure of the article using an X-ray tomographic analysis technique. The method makes it possible to authenticate an article which is characterized by a reference plane and at least one section plane parallel to the reference plane and including the image of at least one marker element (50).

The present invention relates to authenticatable three-dimensional articles, such as works of art, and to a method of protecting and identifying articles made by a foundry or like technique.

More particularly, the present invention seeks to enable articles such as works of art, precious articles, jewelry, unique castings, or industrial components made by a foundry technique or an analogous casting technique to be protected and to be identified so as to prevent illegal reproductions or falsifications or so as to enable them to be detected.

The invention thus seeks to give an unfalsifiable identity to each individual protected article, such as works of art or precious articles, specifically in order to guarantee that the articles concerned retain their value.

Any work of art, any precious or unique article, whether of an ornamental or of an industrial nature, can be copied, even if the article is three-dimensional. This is very harmful both in terms of the intrinsic value of such articles and in terms of the exclusive rights that artists, crafts workers, jewelers, engineers, and manufacturing businesses can legitimately exercise.

Regardless of whether the article is a sculpture, a piece of jewelry, or a high technology industrial component, it is entirely possible for a label, a number, a stamp, or a bar code to be deleted, modified, falsified and finally destroyed, made illegible or unusable or indeed reproduced by imitation.

In particular in the context of manufacturing bank notes or plastics cards, proposals have already been made to include identification elements in the very material of an article, which elements are in the form of balls or bubbles that are different in kind from the main material of the article and that can be constituted in particular by colored elements distributed in non-uniform manner in the body of the article so as to define a code and enable investigation means that are not destructive to the structure of the article to respond thereto in a manner which is different from the way they respond to the main material of the article, said means relying essentially on visual observation.

Known methods are not applicable to three-dimensional metal articles insofar as they rely on visual observation by means that are essentially optical and often require the use of special substances, such as fluorescent chemicals or liquid salts to make detection possible, thus making the method difficult to implement.

The present invention seeks to remedy the above-mentioned drawbacks and to make it easy to identify a three-dimensional metal article made using a foundry or like technique, the method guaranteeing reliable verification of authenticity and preventing any falsification or counterfeiting of the article.

These objects are achieved by a method of protecting and identifying a three-dimensional article such as a work of art, a precious article, or an industrial component, manufactured by a foundry, casting, or like technique, in which marker elements are included in the main material of the article during manufacture, the marker elements being different in kind from the main material of the article so as to be capable of presenting a response to means for non-destructive investigation of the internal structure of the article that is different from the response of said main material of the article, the method being characterized in that metal marker elements are selected that are constituted by balls presenting a melting point higher than that of the main metal material of the article, the marker elements are introduced while in the solid state and in random manner into the liquid main material of the article while it is being cast and without premixing, and after the article has been made, it is identified by locating marker elements within the internal structure of the article using an X-ray tomography analysis technique.

After casting and introducing the marker elements, a reference plane is specified defining the positioning of the article, section planes are selected parallel to the reference plane and defined by their height relative to the reference plane and by their thickness, and pictures are taken that are the results of tomographic X-ray examination of the article in the planes as defined in this way, graphics documents are produced, and the position of at least one marker element is measured and marked on said graphics documents.

An identity card for the article is drawn up on the basis of the data in the graphics documents.

Each marker element is made of a material that presents characteristics that are neutral relative to the main material of the article.

The marker elements are included in the main material of the article in such a manner as to ensure that they are all invisible from the outside.

Each marker element can be a ball having a diameter lying in the range about 0.2 millimeters (mm) to 3 mm. A diameter of about 1 mm constitutes a value that is generally satisfactory, but it is possible to select a smaller size. In particular, when the method is applied to articles of small size, such as pieces of jewelry, the marker elements can be constituted by particles of diameter smaller than the values given above, providing the resolution of the tomography used enables them to be observed.

By way of example, the main material of the article to be protected is bronze and the material of a marker element is chromium steel.

Nevertheless, the invention also applies in the same manner to articles made of gold or of other metals or alloys.

The invention also provides an authenticatable three-dimensional article such as a work of art, a precious article, or an industrial component made by a foundry, casting, or like technique and incorporating marker elements in its main material, the marker elements being different in kind from the main material of the article so as to be capable of presenting a response to means for non-destructive investigation of the internal structure of the article that is different from the response of said main material of the article, the article being characterized in that it has solid metal marker elements constituted by balls distributed in random manner in the main metal material of the article and presenting a melting point that is higher than that of the main metal material of the article, and in that it is associated with an identity card identifying a reference plane defining the positioning of the article together with at least one section plane parallel to the reference plane, whose position is identified relative to the reference plane, and which includes the image of at least one marker incorporated in the main material of the article.

The invention also provides a method of inspecting an authenticatable three-dimensional article such as a work of art, a precious article, or an industrial component made by a foundry, casting, or like technique and incorporating marker elements in its main material, the marker elements being different in kind from the main material of the article so as to be capable of presenting a response to means for non-destructive investigation of the internal structure of the article that is different from the response of said main material of the article, the method being characterized in that during manufacture of the article, solid metal marker elements are introduced randomly into the main material of the article while it is in the liquid state and is being cast, the marker elements being constituted by balls having a melting point higher than that of the main metal material of the article; after the article has been made, a reference plane is determined defining the positioning of the article, and the article is digitized in three dimensions by making a succession of contiguous tomographic sections on planes parallel to the reference plane, each section plane being defined by its height relative to the reference plane and by its thickness, at least one tomographic section is selected that intercepts at least one marker element, the position of said marker element in the selected section plane is identified, an identity card for the article is drawn up comprising firstly information relating to the main characteristics of the article and secondly a representation of at least one selected tomographic section, and during subsequent inspection of the article by tomography, at least one tomographic section is acquired corresponding to a selected tomographic section, and if a marker element is recognized therein positioned in the manner that is identified in the selected tomographic section, then the three-dimensional article is validly authenticated.

In order to increase the security of an authentication check, it is possible to archive at least one selected tomographic section showing an identified marker element as published on the identity card of the authenticatable three-dimensional article in digital or photographic form, together with at least one additional selected tomographic section showing another identified marker element but that is not published on the main identity card associated with the article.

Other characteristics and advantages of the invention appear from the following description of particular embodiments given as examples and described with reference to the accompanying drawings, in which:

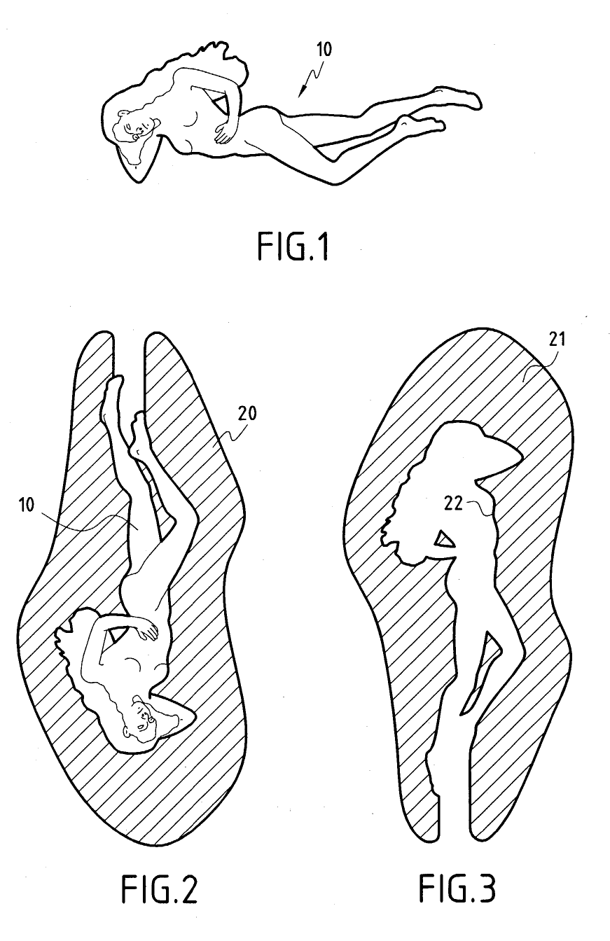

FIG. 1 shows a wax statuette created by a sculptor;

FIG. 2 shows a refractive shell being made around the FIG. 1 statuette;

FIG. 3 shows a mold being made from the FIG. 2 refractory shell after the wax of the FIG. 1 statuette has been eliminated;

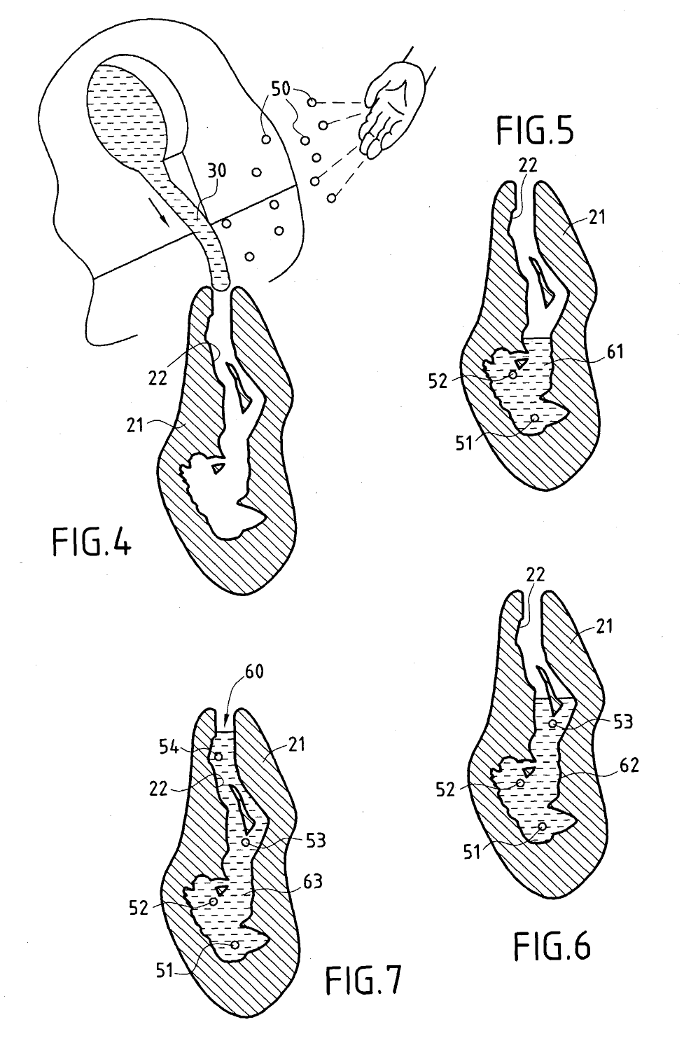

FIGS. 4 to 7 show the various steps in a process of casting in the FIG. 3 mold while applying the method of the invention;

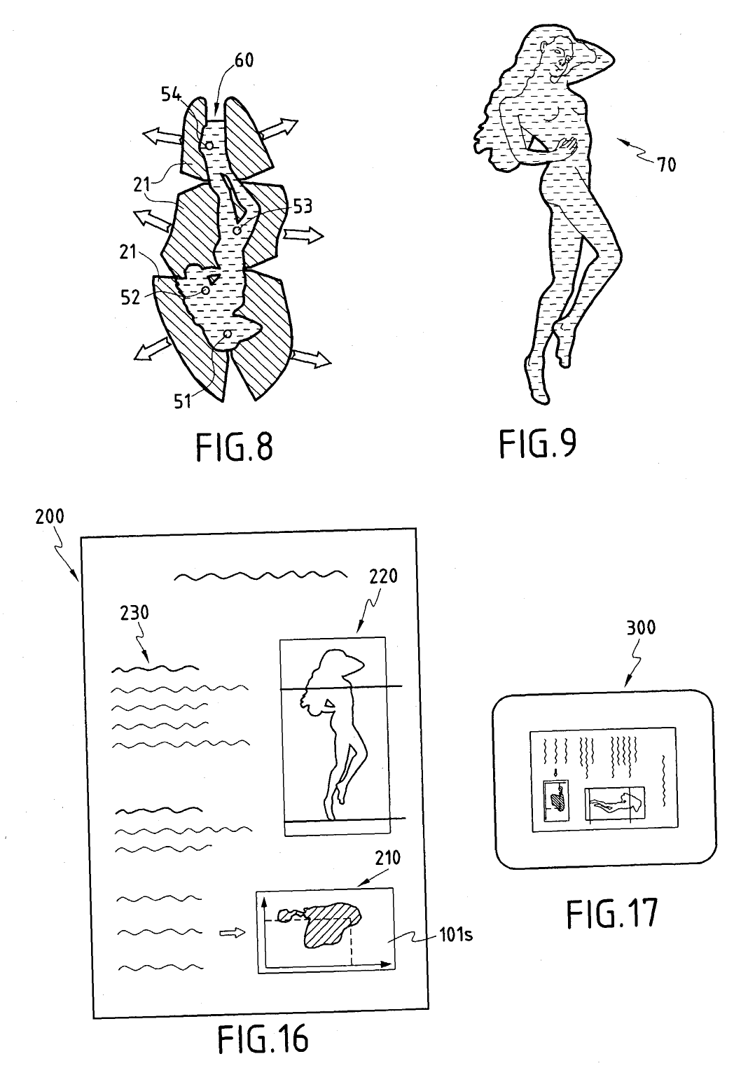

FIG. 8 shows the step of unmolding the article formed in the steps of FIGS. 4 to 7 by destroying the mold;

FIG. 9 shows the appearance of the final article as obtained by the method of the invention;

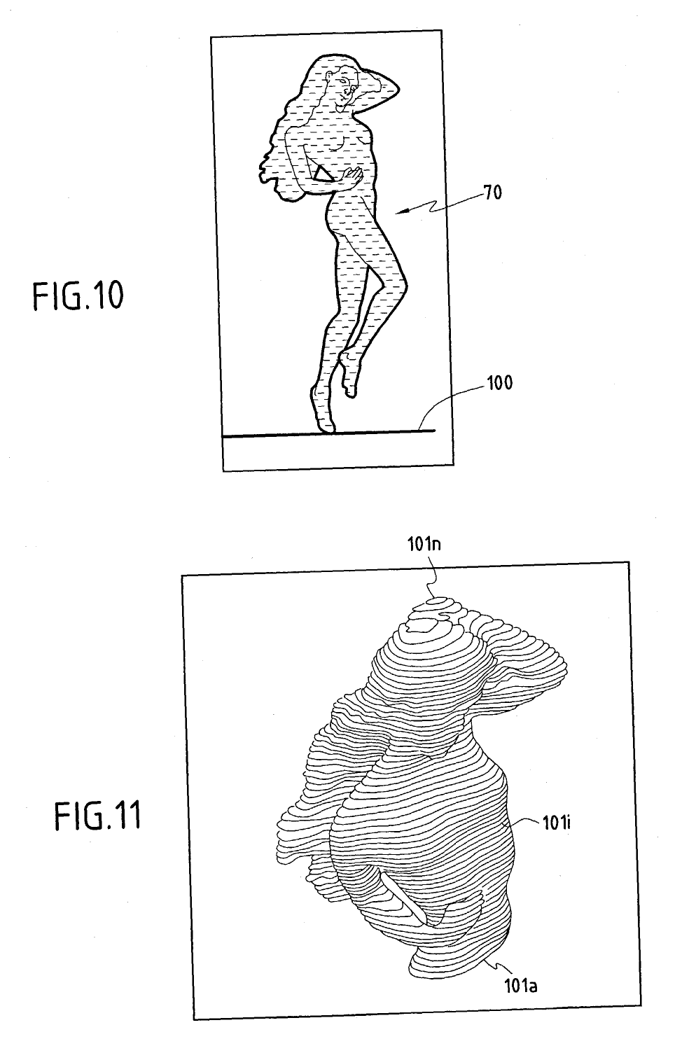

FIG. 10 shows how a reference plane is defined for the FIG. 9 article;

FIG. 11 shows the contiguous tomographic sections being made on the basis of the FIG. 10 article;

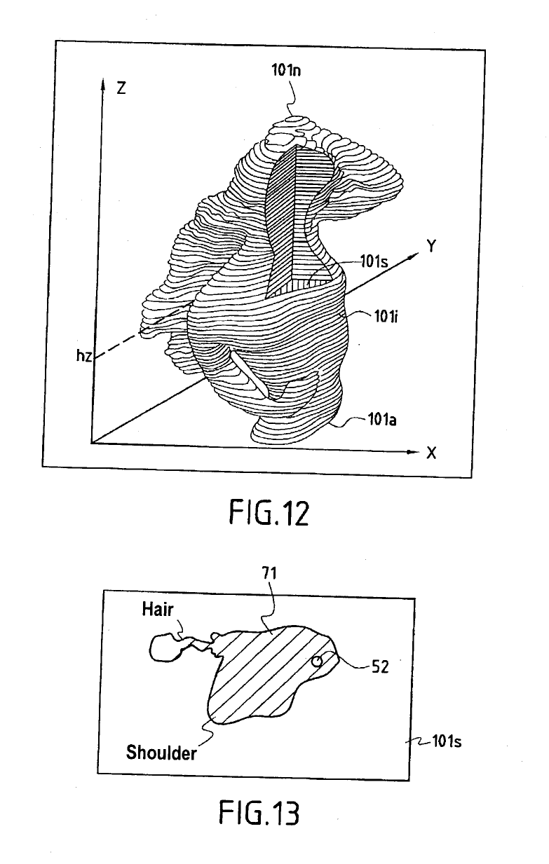

FIG. 12 shows the selection of a useful tomographic section from the sections of FIG. 11;

FIG. 13 shows the useful tomographic section as selected and extracted;

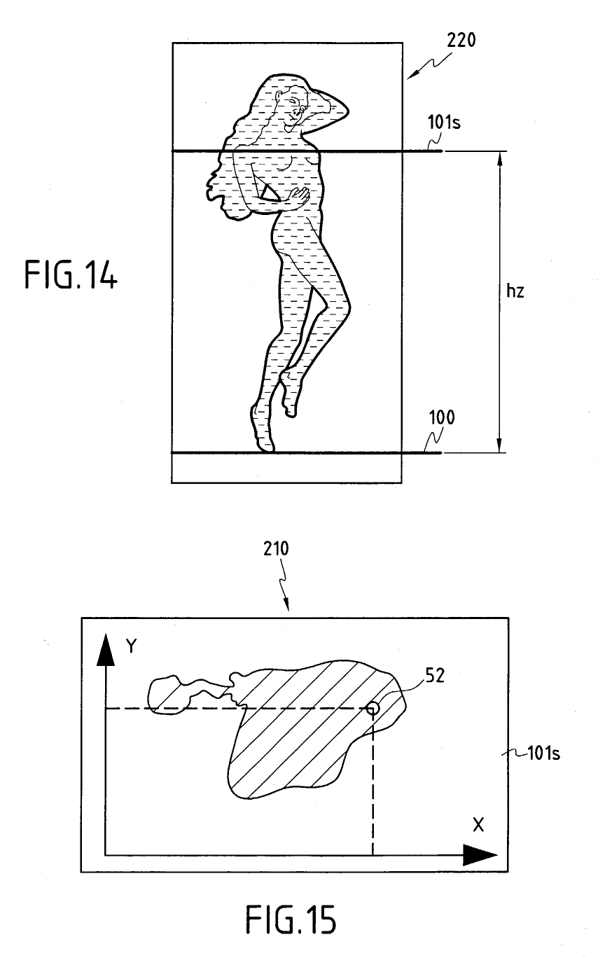

FIGS. 14 and 15 show two identification images for the created article;

FIG. 16 shows an example of an identity record for the created article; and

FIG. 17 shows an example of archiving identification data for a created article that can be authenticated using the method of the invention.

When making an article by the foundry technique or by any like technique, the method of the invention consists essentially of including marker elements in the article that are different in kind from the main metal. The random disposition of the marker elements characterizes the article: specifying the positions of a certain number of marker elements makes it possible to draw up an identity card for the article, and by subsequently analyzing the article it is possible to verify whether it complies with the information given in its identity card, thus making it possible to detect any alteration of the article or any unauthorized copying thereof. The very way in which the marker elements are introduced makes it impossible to produce two successive articles having the same distribution of marker elements, i.e. presenting the same identifier.

The method of the invention consists in including small-sized marker elements in the molten metal during the operation of casting or the like, said elements being constituted by balls preferably of a diameter lying in the range about 0.2 mm to 3 mm, and for example being about 1 mm. The melting point of the marker elements is higher than that of the main metal of the article being made and their readability during an X-ray inspection using a tomographic technique is distinguishable from that of the main metal. The marker elements included in the main material are selected so as to avoid having any side effects on the main metal, particularly in terms of electrolytic couple, oxidation, and mechanical effects. For example, chromium steel balls can be integrated in a bronze casting.

The method of the invention consists in distributing the markers in random manner during casting.

According to the invention, the stochastically, i.e. randomly, distributed markers are located within the article. This is achieved by the fact that the markers are introduced into the molten metal while they are in the solid state and without any premixing, with this being done specifically during the operation of casting the article in a mold.

Thereafter the marker elements remain embedded in the mass of the article as it solidifies. The article, for example a sculpture, thus contains within itself a topological arrangement that is unique, specific, impossible to change, and unfalsifiable.

The random nature of the throw of balls into the main molten metal cast into the mold, and the resulting distribution of the balls are as chancy as the effects obtained when throwing dice. There is no rational means for discovering in normal manner the topographical distribution of the marker elements which remains secret unless an X-ray tomography analysis technique is used, and furthermore there is no way of identically reproducing such a distribution of marker elements that cannot be seen and that are distributed in random manner.

The marker elements can be located and the geometrical relationships they have relative to one another can be identified during an operation performed using the X-ray tomography technique which constitutes means for non-destructive three-dimensional inspection of zones inside the article.

This tomographic analysis method makes it possible both to draw up an authentication certificate for the article by an initial identification of the positions of one or more marker elements within the volume of the article, and also to detect fraudulent duplicates that might be made of the article during subsequent analysis using the same X-ray tomography technique on a disputed article, thereby detecting or failing to detect marker elements corresponding to those identified in the authentication certificate that was drawn up on performing the initial analysis by tomography on the original finished article.

The invention defines precisely the conditions under which the operation of identifying the positions of the marker elements is to be performed so as to make it possible to repeat the operation in the event of an inspection being performed subsequently on the article in question.

A reference plane associated with the article is thus defined and explained in various ways, for example using text, diagrams, or photographs. The reference plane is selected in such a manner that it is easy to reproduce the position of the article relative to the reference plane.

Once the reference plane has been determined, the article is subjected to X-ray tomography on contiguous section planes parallel to the reference plane and identified by their heights relative to the reference plane and by their thicknesses.

Then one or more section planes are selected in which there appear one or more marker elements, and the location of the or each marker element within the selected section plane(s) is identified.

One or more photographs corresponding to the selected tomographic section planes serve to display the location of marker elements included in the article and acting as identifiers. In addition to photographs, additional information can serve to define very accurately the positions of the various marker elements (in terms of distances between pairs of marker elements, distance between a marker element and the surface of the article).

The data defining the position of one or more marker elements and the graphics documents associated therewith can be. used to draw up an identity card for the article, thus enabling it to be authenticated. The various data and associated graphics documents can be stored in digital form. It is important for this information to include instructions on how to reproduce documents comparable to the original identity card that constitutes an authentication certificate in the event of a check being performed subsequently. Specifying the reference plane and the height and the thickness of each section plane is necessary, as is specifying the geometrical coordinates of one or more identified marker elements.

Thus, whenever a check is to be made on an article, artists, crafts workers, manufacturers, engineers, or any other person who has adopted the method of protecting, identifying, and authenticating articles in accordance with the invention can, by producing the authentication certificate, demonstrate that an article was produced by them or demonstrate that it is a forgery.

There follows a description with reference to FIGS. 1 to 17 of an example of an application of the invention to a method of identifying and protecting against counterfeiting three-dimensional metal articles created in an art foundry, thus making it possible to provide three-dimensional articles that are capable of being authenticated, and of value that can be guaranteed insofar as unauthorized copies can be detected reliably.

The main steps of the method applied to an artistic casting protected against counterfeiting are as follows:

A first stage consists in making a molded metal article that contains marker elements.

During this first stage, the sculptor begins by making an original work 10 in wax, such as a statuette (FIG. 1).

A founder then makes a refractory shell 20 around the wax model 10, by dipping it in a cold liquid ceramic and drying it (FIG. 2).

The process of shell formation can comprise a plurality of successive steps in which the wax model 10 is immersed in a colloidal suspension of ceramic and then dried, until a shell 20 of sufficient thickness if obtained.

In a following step, the wax 10 is eliminated by heating the shell 20, and the shell 20 is then fired so as to give it good mechanical strength enabling it to act properly as a mold 21 presenting a cavity 22 (FIG. 3).

In the following step, which constitutes an important feature of the present invention, the founder inserts simultaneously into the mold 21 both a molten metal or metal alloy 30 such as liquid bronze coming from a tank furnace 40, together with a certain number of marker elements 50 such as small steel balls which are thrown randomly into the stream of the main material 30 throughout the casting operation. The number and the size of the marker elements 50 must be adapted to the volume of the mold cavity, and the space occupied by the marker elements 30 must remain small compared with the space occupied by the main material. The number of markers 50 can thus be a few to a few tens. The balls 50 are advantageously about 1 mm in diameter.

FIGS. 4 to 7 show the various successive states during casting in the cavity 22 of the mold 21. FIG. 4 shows an initial state at the beginning of casting. FIG. 5 shows the cavity 22 of the mold 21 filled about half-full with the main material 61 coming from the molten stream 30, together with two marker elements 51 and 52 that are already embedded in the main material 61. FIG. 6 shows the cavity 22 of the mold 21 containing a larger quantity of the main material 62 and a larger number of marker elements 51, 52, and 53 embedded in the main material 62.

FIG. 7 shows the state of the mold 21 at the end of casting with its cavity 22 being completely full of the main material 63 which, on cooling, solidifies and incorporates a certain number of marker elements 51 to 54 embedded in the mass of the molded article 60, which elements are distributed in random manner.

FIG. 7 shows four marker elements 51 to 54 constituted by balls incorporated in the article 60 that have been made by casting. Nevertheless, the number of balls embedded therein could naturally be greater, providing the total volume occupied by the balls remains small compared with the volume occupied by the main material of the molded article.

After the molten metal previously inserted into the mold 21 together with the marker elements 51 to 54 has cooled and solidified, the ceramic mold 21 is destroyed mechanically so as to unmold the article 60 (FIG. 8).

After unmolding, various finishing operations are performed on the casting 60 such as eliminating surface irregularities, eliminating any marker elements that are visible at the surface, given that the marker elements must remain invisible, and forming patina.

At the end of this initial stage of making the casting, a finished product is obtained such as a statuette or figurine 70 as shown in FIG. 9, which includes unalterable markers distributed randomly in the mass of the article and invisible from the outside, being undetectable using conventional visual observation means such as optical means.

In a second stage of the method of the invention, one or more marker elements 51 to 54 inside the main metal constituting the article 70 that has been made are detected and located in three dimensions.

In a first step, a reference plane is determined that is easily identifiable relative to the article 70. For example, with the statuette of FIG. 10 representing a young woman, the reference plane 100 is horizontal relative to the person placed in an upright position, and the reference plane passes via the tip of the statuette's left foot.

As shown in FIG. 11, n contiguous tomographic sections are taken 101a, . . . , 101i, . . . , 101n constituting a three-dimensional digitization of the entire article 70 or of a substantial portion thereof (FIG. 11). The n tomographic sections made on the basis of X-ray radiography are all parallel to the reference plane 100 and they are defined in terms of thickness and height h relative to the reference plane 100.

From the set of tomographic sections made in this way, only those which intercept a marker element 51 to 54 are of use. Of these useful sections, one or two sections are selected for conservation purposes. FIG. 12 shows a section 101s being selected as defined by a height hz, and including a marker element 52.

FIG. 13 shows the tomographic section 101s on its own together with the area 71 occupied by the article 70 at height hz, showing that within this area there is the image of a marker element 52. Legends such as “hair” and “shoulder” serve to identify the parts of the body of the figurine that can be seen in the area 71.

A document combining the main characteristics of the article 70 constitutes an identification record 200 having various kinds of information together with graphical data, in particular a view 210 of a tomographic section 101s that includes the image of a marker 52 (FIG. 15) and preferably a view 220 of the article 70 (FIG. 14) enabling the reference plane 100 and the selected section plane 101s to be identified.

The identification record 200 must thus make it possible to identify accurately within the volume of the article the position of a given marker element such as the element 52, together with the conditions of observation so that a subsequent inspection can be performed under the same conditions of tomographic acquisition, thereby locating again the same marker 52 and thus identifying the article with certainty, thereby confirming its authenticity.

By way of example, the identity record 200 for a statuette can comprise general data such as the name of the sculptor, the title of the work, its creation date, the name of the founder, the casting date, the number of copies to be made, the nature of its main material, the dimensions and the weight of the article, and a work number.

Regardless of whether the article is a work of art or an industrial product, its identity record 200 also contains sufficient information about tomographic identification. This information can comprise the origin and the date of the tomographic inspection, instructions on identifying the reference plane (e.g. “press against the left foot”, as shown in FIG. 14), the height hz of the section plane relative to the reference plane 140 (e.g. hz=165 mm), the thickness of the section plane (e.g. 2 mm), and the XY coordinates of the marker element in the selected tomographic section plane 101s at height hz (e.g. X=80 mm, Y=40 mm).

An identity record 200 as shown in FIG. 16 including both graphics elements 210, 220 and data 230 concerning general information or tomographic identification can be printed on paper and then photographed and stored on color film, or in black and white, e.g. in the form of a color slide 300 (FIG. 18).

The general data 230 and the tomographic identification data together with the graphics elements 210, 220 can also be archived in digital form on media that guarantee good conservation of data and the ability to continue being able to use the data in the long term.

For each article, the archive can include not only the tomographic section published in the identity record, but also another tomographic section that is not published and that also reveals a marker element and that can serve as an additional guarantee in the event of a dispute.

1/ A method of protecting and identifying a three-dimensional article such as a work of art, a precious article, or an industrial component, manufactured by a foundry, casting, or like technique, in which marker elements are included in the main material of the article during manufacture, the marker elements being different in kind from the main material of the article so as to be capable of presenting a response to means for non-destructive investigation of the internal structure of the article that is different from the response of said main material of the article, the method being characterized in that metal marker elements are selected that are constituted by balls presenting a melting point higher than that of the main metal material of the article, the marker elements are introduced while in the solid state and in random manner into the liquid main material of the article while it is being cast and without premixing, and after the article has been made, it is identified by locating marker elements within the internal structure of the article using an X-ray tomography analysis technique.

2/ A protection and identification method according to claim 1, characterized in that after casting and introducing the marker elements, a reference plane is specified defining the positioning of the article, section planes are selected parallel to the reference plane and defined by their height relative to the reference plane and by their thickness, and pictures are taken that are the results of tomographic X-ray examination of the article in the planes as defined in this way, graphics documents are produced, and the position of at least one marker element is measured and marked on said graphics documents.

3/ A protection and identification method according to claim 2, characterized in that an identity card for the article is drawn up on the basis of the data in the graphics documents.

4/ A protection and identification method according to any one of claims 1 to 3, characterized in that each marker element is made of a material that presents characteristics that are neutral relative to the main material of the article.

5/ A protection and identification method according to any one of claims 1 to 4, characterized in that the marker elements are included in the main material of the article in such a manner as to ensure that they are all invisible from the outside.

6/ A protection and identification method according to any one of claims 1 to 5, characterized in that each marker element is a ball having a diameter lying in the range about 0.2 mm to about 3 mm.

7/ A protection and identification method according to any one of claims 1 to 6, characterized in that the main material of the article to be protected is bronze and the material of a marker element is chromium steel.

8/ An authenticatable three-dimensional article such as a work of art, a precious article, or an industrial component made by a foundry, casting, or like technique and incorporating marker elements in its main material, the marker element being different in kind from the main material of the article so as to be capable of presenting a response to means for non-destructive investigation of the internal structure of the article that is different from the response of said main material of the article, the article being characterized in that it has solid metal marker elements constituted by balls distributed in random manner in the main metal material of the article and presenting a melting point that is higher than that of the main metal material of the article, and in that it is associated with an identity card identifying a reference plane defining the positioning of the article together with at least one section plane parallel to the reference plane, whose position is identified relative to the reference plane, and which includes the image of at least one marker incorporated in the main material of the article.

9/ An authenticatable three-dimensional article according to claim 8, characterized in that each marker element is a ball having a diameter lying in the range about 0.2 mm to 3 mm.

10/ An authenticatable three-dimensional article according to claim 8 or claim 9, characterized in that the main material of the article to be protected is bronze and the material of a marker element is chromium steel.

11/ A method of inspecting an authenticatable three-dimensional article such as a work of art, a precious article, or an industrial component made by a foundry, casting, or like technique and incorporating marker elements in its main material, the marker elements being different in kind from the main material of the article so as to be capable of presenting a response to means for non-destructive investigation of the internal structure of the article that is different from the response of said main material of the article, the method being characterized in that during manufacture of the article, solid metal marker elements are introduced randomly into the main material of the article while it is in the liquid state and is being cast, the marker elements being constituted by balls having a melting point higher than that of the main metal material of the article; after the article has been made, a reference plane is determined defining the positioning of the article, and the article is digitized in three dimensions by making a succession of contiguous tomographic sections on planes parallel to the reference plane, each section plane being defined by its height relative to the reference plane and by its thickness, at least one tomographic section is selected that intercepts at least one marker element, the position of said marker element in the selected section plane is identified, an identity card for the article is drawn up comprising firstly information relating to the main characteristics of the article and secondly a representation of at least one selected tomographic section, and during subsequent inspection of the article by tomography, at least one tomographic section is acquired corresponding to a selected tomographic section, and if a marker element is recognized therein positioned in the manner that is identified in the selected tomographic section, then the three-dimensional article is validly authenticated.

12/ A method of inspection according to claim 11, characterized in that at least one selected tomographic section showing an identified marker element as published on the identity card of the authenticatable three-dimensional article is archived in digital or photographic form, together with at least one additional selected tomographic section showing another identified marker element but that is not published on the main identity card associated with the article.
